(19) United States
(12) Patent Application Publication
(10) Pub. No.: US 2012/0018451 A1
(43) Pub. Date: Jan. 26, 2012

(54) CARTRIDGE HAVING LIGHT GUIDE

(75) Inventors: Salvatore Fileccia, Oberhausen (DE); Arnd Kessler, Monheim am Rhein (DE); Dieter Eichholz, Iserlohn (DE); Hans-Georg Mühlhausen, Dusseldorf (DE); Christian Nitsch, Dusseldorf (DE); Thorsten Bastigkeit, Wuppertal (DE)

(73) Assignee: HENKEL AG & CO. KGaA, Dusseldorf (DE)

(21) Appl. No.: 13/207,736

(22) Filed: Aug. 11, 2011

Related U.S. Application Data
(63) Continuation of application No. PCT/EP2010/000455, filed on Jan. 27, 2010.

(30) Foreign Application Priority Data
Feb. 16, 2009 (DE) 10 2009 009 118.1

(51) Int. Cl. B67D 7/74

(52) U.S. Cl. 222/129

(57) ABSTRACT

The invention relates to a cartridge for coupling to a metering device for dispensing at least one washing and/or cleaning agent preparation from the cartridge into the inside of a household appliance, wherein the cartridge comprises at least one chamber for storing at least one free-flowing or pourable washing and/or cleaning agent preparation, wherein at least one light guide into which a light signal can be coupled from outside of the cartridge is arranged in or on the cartridge.

### CROSS-REFERENCES TO RELATED APPLICATIONS

This application is a continuation of PCT/EP2010/000455, filed on Jan. 27, 2010, which claims priority under 35 U.S.C. §119 to DE 10 2009 009 118.1 filed on Feb. 16, 2009.

### FIELD OF THE INVENTION

The present invention generally relates to a cartridge, to a dispenser for coupling to a cartridge, and to a dispensing system for delivering a plurality of preparations for use in water-conveying equipment, and more particularly relates to water-conveying household appliances, for example automatic dishwashers, washing machines, laundry driers, or automatic surface cleaning systems.

### BACKGROUND OF THE INVENTION

Automatic dishwashing agents are available to consumers in a plurality of presentations. In addition to traditional liquid manual dishwashing agents, automatic dishwashing agents have in particular become increasingly significant as household automatic dishwashers have become more common. These automatic dishwashing agents are typically offered to the consumer in solid form, for example as a powder or as tablets, but increasingly also in liquid form. For some time, attention has focused chiefly on convenient dispensing of washing and cleaning agents and on simplifying the working steps required to carry out a washing or cleaning method.

Furthermore, one of the main objectives of manufacturers of automatic cleaning agents is to improve the cleaning performance of these agents, increasing attention recently having been paid to cleaning performance in low-temperature cleaning cycles or in cleaning cycles having reduced water consumption. To this end, new ingredients, for example more-effective surfactants, polymers, enzymes or bleaching agents, have been added to the cleaning agents. Because new ingredients are available only to a limited extent, however, and because for environmental and economic reasons the quantity of the ingredients used per cleaning cycle cannot be arbitrarily increased, there are natural limits to this approach to a solution.

In this connection, apparatuses for multiple dispensing of washing and cleaning agents have very recently come under scrutiny by product developers. With regard to these apparatuses, a distinction may be made between on the one hand dispensing chambers integrated into the automatic dishwasher or textile washing machine, and on the other hand separate devices independent of the automatic dishwasher or textile washing machine. By means of these apparatuses, which contain several times the quantity of cleaning agent required to carry out a cleaning method, washing- or cleaning-agent portions are automatically or semi-automatically dispensed into the interior of the cleaning machine in the course of multiple successive cleaning processes. For the consumer, the need for manual dispensing for each cleaning or washing cycle is eliminated. Examples of such apparatuses are described in European patent application EP 1 759 624 A2 (Reckitt Benckiser) or in German patent application DE 53 5005 062 479 A1 (BSH Bosch and Siemens Hausgeräte GmbH).

Accordingly, it is desirable to make available an improved dispenser, an improved cartridge, and/or an improved dispensing system.

Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1. Autonomous dispenser with two chamber cartridge, in the separated and assembled states;

FIG. 2. Autonomous dispenser with two chamber cartridge, arranged in a drawer of an automatic dishwasher;

FIG. 3. Two chamber cartridge, separated into an autonomous dispenser and an internal machine-integrated dispenser;

FIG. 4. Two chamber cartridge, assembled with an internal machine-integrated dispenser;

FIG. 5. Two chamber cartridge, separated into an autonomous dispenser and external machine-integrated dispenser;

FIG. 6. Two chamber cartridge, assembled with an external machine-integrated dispenser;

FIG. 7. Two chamber cartridge, in the separated state and assembled into an autonomous appliance-integratable dispenser;

FIG. 8. Two chamber cartridge, assembled with an autonomous machine-integrated dispenser;

FIG. 9. Autonomous dispenser with refillable two chamber cartridge and refill unit;

FIG. 10. Cartridge formed from a trough-shaped and a cover-shaped cartridge element;

FIG. 11. Cartridge formed from two trough-shaped cartridge elements;

FIG. 12. Cartridge formed from a cell-shaped, bottomless container and a cartridge bottom;

FIG. 13. Cartridge formed from a cell-shaped container open at the top, having a cartridge cover;

FIG. 14. Cartridge formed from two chamber elements;

FIG. 15. Cartridge with refill pouch;

FIG. 16. Cartridge with chamber for delivering volatile substances;

FIG. 17. Front view of cartridge with three chambers;

FIG. 18. Plan view of cartridge with three chambers;

FIG. 19. Exploded depiction of two-part cartridge with a trough-shaped and a plate-like cartridge element;

FIG. 20. Exploded depiction of two-part cartridge with a cell-like container and a cartridge bottom;

FIG. 21. Perspective view of three chamber cartridge with dispenser, in the separated state;

FIG. 22. Perspective view of three chamber cartridge with vent openings;

FIG. 23. Perspective inside view into a three chamber cartridge with front wall removed;

FIG. 24. Longitudinal sectioned view into a three chamber cartridge;

FIG. 25. Longitudinal sectioned view of a three chamber cartridge coupled to the dispenser;

FIG. 26. Schematic diagram of configuration of the vent conduit on a separating web of the cartridge;

### LIST OF REFERENCE CHARACTERS

1 Cartridge
2 Dispenser
3 Chamber
4 Cartridge bottom
5 Outlet opening
6 Half-shell-shaped element
7 Half-shell-shaped element
8 Connecting edge
9 Separating web
10 Cartridge top
11 Cartridge side surface
12 Cartridge side surface
13 Cartridge front wall
14 Cartridge back wall
15 Energy source
16 Control unit
17 Sensor unit
18 Actuator
19 Closure element
20 Dispensing chamber
21 Dispensing chamber inlet
22 Dispensing chamber outlet
23 Component carrier
24 Rubber grommet
25 Compensating washer
26 Predispensing chamber
27 Outlet chamber
28 Receptacle
29 Receptacle
30 Fitting
31 Chamber wall
32 Conduit
33 Conduit
34 Opening
35 Seal
36 Seal
37 Indicating and control elements
38 Automatic dishwasher
39 Automatic dishwasher door
40 Preparation
41 Tableware drawer
42 Adapter
43 Depression
44 Holding elements
45 Chamber
46 Opening
47 Interface
48 Interface
49 Opening
50 Adapter
51 Refill cartridge
52 Chamber
53 Dispensing chamber
54 Bracket
55 Hinge
56 Hook
57 Permanent magnet
58 Coil
59 Coil
60 Holding point
61 Holding point
62 Bottom
63 Conduit
64 Pouch
65 Opening
66 Material bridge
67 Pressure washer
68 Cleaning robot
69 Valve
70 Vehicle
71 Water tank
72 Pump
73 Nozzle
74 Steam iron
75 Plant watering system
76 Sensor
77 Adapter
78 Water inflow connection
79 Water inflow connection
80 Seal
81 Vent opening
82 Vent conduit
83 Vent conduit orifice
84 Web
85 Web
86 Vent chamber
F Fill level
Hₘₐₓ Maximum fill height

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The dispensing system according to the invention is made up of the basic components of a cartridge filled with preparation and a dispenser couplable to the cartridge, which dispenser is in turn formed from further subassemblies such as, for example, a component carrier, actuator, closure element, sensor, energy source, and/or control unit.

It is preferred that the dispensing system according to the present invention be movable. For purposes of the present Application, “movable” means that the dispensing system is not nondetachably connected to a water-conveying apparatus such as, for example, an automatic dishwasher, washing machine, laundry dryer, or the like, but instead is removable, for example, from an automatic dishwasher or positionable in an automatic dishwasher by the user, i.e. can be handled independently.

According to an alternative embodiment of the invention, it is also conceivable for the dispenser to be connected, nondetachably for the user, to a water-conveying apparatus such as, for example, an automatic dishwasher, washing machine, laundry dryer, or the like, and for only the cartridge to be movable.

In order to ensure operation at elevated temperatures such as those that occur in individual washing cycles of an automatic dishwasher, the dispensing system may be formed from materials that are dimensionally stable up to a temperature of 120° C.

Because the preparations to be dispensed may have a pH between 2 and 12 depending on the intended utilization, all components of the dispensing system that come into contact with the preparations should exhibit appropriate acid and/or alkali resistance. In addition, suitable material selection should ensure that these components are largely chemically inert, for example with respect to nonionic surfactants, enzymes and/or scents.

### Cartridge

For purposes of the present Application, a “cartridge” is understood as a packaging means that is suitable for encasing or holding together flowable or pourable preparations, and is couplable to a dispenser for delivering at least one preparation.

In particular, a cartridge can also encompass multiple chambers that are fillable with compositions differing from one another. It is also conceivable for a plurality of containers to be arranged into a cartridge unit.

It is advantageous for the cartridge to comprise at least one outlet opening which is arranged such that gravity-effected release of preparation out of the container can be brought about in the utilization position of the dispenser. As a result, no further conveying means are required for the release of preparation from the cartridge, so that the construction of the dispenser can be kept simple and manufacturing costs low.

In a preferred embodiment of the invention, at least one second chamber is provided for receiving at least one second flowable or scatterable preparation, the second chamber comprising at least one outlet opening which is arranged such that a gravity-effected product release from the second chamber can be brought about with the dispenser in the utilization position. The arrangement of a second chamber is particularly advantageous when preparations that are not usually shelf-stable with one another, for example bleaching agents and enzymes, are stocked in the mutually separate containers.

It is furthermore conceivable for more than two, in particular three to four chambers to be provided in or on a cartridge. In particular, one of the chambers can be configured to deliver volatile preparations, for instance a scent, into the environment.

In a further embodiment of the invention, the cartridge is embodied in one piece. As a result, the cartridges can be embodied economically in one manufacturing step, in particular using suitable blow molding methods. The chambers of a cartridge can in this context be separated from one another by, for example, webs or material bridges.

The cartridge can also be formed from multiple pieces, using components manufactured by injection molding and then joined together.

In addition, it is conceivable for the cartridge to be shaped in multi-piece fashion such that at least one chamber, preferably all the chambers, are individually removable from or insertable into the dispenser. This makes it possible, if a preparation from one chamber is being used at a different rate, to replace an already empty chamber while the others, which may still be filled with preparation, remain in the dispenser. Targeted and demand-compatible refilling of the individual chambers or their preparations can thereby be achieved.

The chambers of a cartridge can be fastened to one another using suitable connection methods, thereby forming a container unit. The chambers can be fastened detachably or nondetachably to one another by a suitable positive, frictionally engaged, or intermaterial connection. In particular, fastening may be effected by one or more of the connection types from the group of the snap-in connections, hook-and-loop connections, press connections, melt connections, adhesive connections, welded connections, soldered connections, screw connections, keyed connections, clamped connections or flip-closure connections In particular, fastening may also be embodied by a heat-shrink sleeve, which in a heated state is pulled over all or portions of the cartridge, and in the cooled state fixedly surrounds the chambers or the cartridge.

In order to provide advantageous residual emptying properties for the chambers, the bottom of the chambers can be inclined in the manner of a funnel toward the delivery opening. Moreover, the inner wall of a chamber may be embodied, by suitable material selection and/or surface configuration, in such a way that little material adhesion of the preparation onto the internal chamber wall occurs. This feature, too, allows the residual emptying capability of a chamber to be further optimized.

The chambers of a cartridge can exhibit identical or differing volumetric capacities. In a configuration having two chambers, the ratio of the chamber volumes is preferably 5:1, in a configuration having three chambers preferably 4:1:1, these configurations in particular being suitable for use in automatic dishwashers.

As mentioned above, the cartridge preferably possesses three chambers. For use of such a cartridge in an automatic dishwasher, it is particularly preferred that the first chamber contain an alkaline cleaning preparation, the second chamber a enzymatic preparation, and the third chamber a rinse aid, the volume ratio of the chambers being equal to approximately 4:1:1.

A dispensing chamber can be embodied in or on a chamber before the outlet opening in the flow direction of the preparation. The dispensing chamber defines the quantity of preparation that, upon the release of preparation from the chamber, is to be delivered to the environment. This is particularly advantageous when the closure element of the dispenser, which brings about delivery of preparation from a chamber to the environment, can be put only into a delivery state and a closed state, without measurement or monitoring of the quantity delivered. The dispensing chamber then ensures that a predefined quantity of preparation is released without direct feedback of the quantity of preparation currently being delivered. The dispensing chambers can be shaped in single- or multi-piece fashion.

According to a further advantageous refinement of the invention, one or more chambers comprise(s) in each case, in addition to an outlet opening, a respective chamber opening closable in liquid-tight manner. This chamber opening makes it possible, for example, to refill the preparation stored in that chamber.

In order to vent the cartridge chambers, it is possible to provide venting capabilities in particular in the top region of the cartridge, to ensure pressure equalization between the interior of the cartridge chambers and the environment as the fill level drops. These venting capabilities can be embodied, for example as a valve, in particular a silicone slit valve, micro-openings in the cartridge wall, or the like.

If, according to a further embodiment, the cartridge chambers are vented not directly but rather via the dispenser, or if no venting is provided, for example when using flexible containers such as for example pouches, this has the advantage that at elevated temperatures in the course of a washing cycle of a dishwasher, a pressure is built up due to heating of the chamber contents, which pressure presses the preparations to be dispensed toward the outlet openings so that a good residual emptying capability for the cartridge is thereby achievable. In addition, with air-free packaging of this kind there is no risk of oxidation of substances of the preparation; this makes a pouch package or even bag-in-bottle package seem useful in particular for oxidation-sensitive preparations.

The volume ratio, calculated from the physical volume of the dispenser and the volumetric capacity of the cartridge, is equal preferably to <1, particularly preferably <0.1, especially preferably <0.05. This ensures that for a predefined total physical volume of the dispenser and cartridge, the predominant proportion of the physical volume is accounted for by the cartridge and the preparation contained therein.

The cartridge usually has a volumetric capacity of <5000 ml, in particular <1000 ml, preferably <500 ml, particularly preferably <250 ml, very particularly preferably <50 ml.

The cartridge can assume any desired three-dimensional shape. It can for example be cubic, spherical or plate-like in configuration.

The cartridge and the dispenser can in particular be configured, with regard to their three-dimensional shape, in such a way that they ensure the least possible loss of useful volume in particular in an automatic dishwasher.

For utilization of the dispenser in automatic dishwashers, it is particularly advantageous to shape the device by analogy with tableware to be cleaned in automatic dishwashers. It can, for example, be plate-shaped, having approximately the dimensions of a dinner plate. As a result, the dispenser can be positioned in space-saving fashion, for example, in the lower rack of the dishwasher. Furthermore, correct positioning of the dispensing unit is immediately and intuitively evident to the user thanks to the plate-like shape. The cartridge preferably has a ratio of height to width to depth of between 5:5:1 and 50:50:1, particularly preferably approximately 10:10:1. The “slender” embodiment of the dispenser and the cartridge makes it possible in particular to position the device in the lower loading rack of an automatic dishwasher in the receptacles provided for plates. This has the advantage that the preparations delivered from the dispenser travel directly into the washing bath and cannot adhere to other items being washed.

Commercially available household automatic dishwashers are usually designed so that provision is made to arrange larger items to be washed, for instance pans or large plates, in the lower rack of the automatic dishwasher. In order to prevent the user from positioning the dispensing system less than optimally in the upper rack, in an advantageous embodiment of the invention the dispensing system is dimensioned so as to enable the dispensing system to be positioned only in the receptacles of the lower rack provided therefor. To this end, the width and height of the dispensing system can be selected to be in particular between 150 mm and 300 mm, particularly preferably between 175 mm and 250 mm

It is also conceivable, however, to embody the dispensing unit in a cup shape, with a substantially circular or square base outline.

In order to provide a direct visual check of the fill level, it is advantageous to shape the cartridge at least in portions from a transparent material.

In order to protect heat-sensitive constituents of a preparation present in a cartridge from the effect of heat, it is advantageous to manufacture the cartridge from a material having a low thermal conductivity.

Another possibility for reducing the influence of heat on a preparation in a chamber of the cartridge is to insulate the chamber using suitable actions, for example by using thermal insulation materials, such as for instance polystyrene foam, which suitably surround the chamber or cartridge entirely or in part.

A further action for protecting heat-sensitive substances in a cartridge, when a plurality of chambers are present, is the arrangement thereof relative to one another.

It is, for example, conceivable for the chamber that contains a heat-sensitive product to be partly or completely surrounded by at least one further chamber filled with a product, the latter product and latter chamber functioning in this configuration as thermal insulation for the surrounded chamber. This means that a first chamber that contains a heat-sensitive product is partly or entirely surrounded by at least one further chamber filled with a product, so that upon heating of the environment, the heat-sensitive product in the first chamber exhibits a slower rise in temperature than do the products in the surrounding chambers.

In order to bring about a further improvement in thermal insulation, when more than two chambers are used the chambers can be arranged one around the other on the principle of Russian dolls, thus forming a multi-layer insulation layer.

It is advantageous in particular for at least one preparation that is stocked in a surrounding chamber to have a thermal conductivity between 0.01 and 5 W/m*K, preferably between 0.02 and 2 W/m*k, particularly preferably between 0.024 and 1 W/m*K.

The cartridge is embodied, in particular, in dimensionally stable fashion. It is also conceivable, however, to configure the cartridge as a flexible packaging means, for instance as a tube. It is furthermore also possible to use flexible containers such as pouches, in particular if they are used in a substantially dimensionally stable receiving vessel in accordance with the “bag-in-bottle” principle. In contrast to the above-described dimensionally stable packaging means (cartridge), the use of flexible packaging means eliminates the need to provide a venting system for pressure equalization.

In a preferred embodiment of the invention, the cartridge comprises an RFID label that at least contains information about the contents of the cartridge and that is readable by the sensor unit.

This information can be used in order to select a dispensing program stored in the control unit. It is thereby possible to ensure that the optimum dispensing program for a specific preparation is always used. Provision can also be made that, in the absence of an RFID label or in the case of an RFID label having an incorrect or defective identifier, no dispensing is performed by the dispensing apparatus and instead an optical or acoustic signal is generated which notifies the user of the presence of the fault.

In order to prevent incorrect use of the cartridge, the cartridges can also comprise structural elements that interact with corresponding elements of the dispenser on the lock-and-key principle, so that for example only cartridges of a specific type can be coupled to the dispenser. This embodiment furthermore makes it possible for information about the cartridge coupled to the dispenser to be transmitted to the control unit, with the result that the dispensing apparatus can be controlled in a manner coordinated with the contents of the corresponding container.

The outlet openings of a cartridge are preferably arranged on a line, thus enabling a slender, plate-shaped embodiment of the dispenser.

In the case of a pot- or cup-shaped embodiment of the cartridge or a pot- or cup-shaped grouping thereof, it can also be advantageous to arrange the delivery openings of the cartridge, for example, in the form of a circular arc.

The cartridge is embodied in particular to receive flowable washing or cleaning agents. Particularly preferably, a cartridge of this kind comprises a plurality of chambers each for spatially separated reception of preparations of a washing or cleaning agent that differ from one another. By way of non-exhaustive example, some possible combinations for filling the chambers with different preparations are listed below:

| Chamber 1 | Chamber 2 | Chamber 3 | Chamber 4 |
|---|---|---|---|
| Alkaline | Enzymatic | Rinse aid | — |
| cleaning | cleaning | | |
| preparation | preparation | | |
| Alkaline | Enzymatic | Rinse aid | Scent |
| cleaning | cleaning | | |
| preparation | preparation | | |
| Alkaline | Enzymatic | Rinse aid | Disinfectant preparation |
| cleaning | cleaning | | |
| preparation | preparation | | |

The cartridge encompasses a cartridge bottom, which in the utilization position is directed downward in the direction of gravity and in which, at least two chambers, there is provided in each case at least one outlet opening arranged on the cartridge bottom.

The cartridge is preferably formed of at least two elements which are bonded together, the connecting edge of the elements at the cartridge bottom extending at a distance from the outlet orifices such that the connecting edge does not intersect with the outlet orifices.

The bonded connection can be produced, for example, by adhesive bonding, welding, soldering, pressing, or vulcanizing.

It is advantageous that the connecting edge extends along the top, bottom, and side surfaces of the cartridge. As a result, two cartridge elements can be manufactured in particular using the injection molding method, such that either both elements are embodied in trough-shaped fashion, or one element is trough-shaped and the second element is cover-like.

To embody a two- or multi-chamber cartridge, at least one of the two cartridge elements can encompass at least one separating web that, when the elements are joined together, separates each two adjacent chambers of the cartridge from one another.

As an alternative to embodying the cartridge from two shell-shaped cartridge elements, it is also conceivable for one cartridge element to be a cell-like container having at least one chamber, and the second element to be the cartridge bottom or top that is connected to the cell-like container in liquid-tight fashion along the connecting edge.

It is of course also conceivable to combine the aforementioned cartridge configurations in any suitable manner. For example, it is possible to form a two-chamber cartridge from one trough-like and one cover-like cartridge element, and to arrange a third single- or multi-piece chamber on the top or the enveloping surface of the cartridge thus formed.

In particular, a further chamber of this kind for receiving a preparation can be arranged on the cartridge and configured so as to bring about a delivery of volatile substances, for example scents, from the preparation into the environment of the chamber.

According to a preferable embodiment of the invention, the outlet openings are each equipped with a closure that, in the state coupled to a dispenser, allows preparation to flow out of the respective chambers and, when the cartridge is in the uncoupled state, substantially prevents an outflow of preparation. The closure is configured in particular as a silicone slit valve.

The cartridge elements forming the cartridge are preferably formed from a plastic, and can be shaped in a shared injection molding process; it may be advantageous in this context to shape on between the two elements a connecting web acting as a hinge, so that after shaping, the two elements are butted against another by folding over, and are bonded along the connecting edge.

In a further embodiment of the invention, an energy source, in particular a battery or rechargeable battery, is arranged on the cartridge, preferably on the bottom of the cartridge. Means for electrically coupling the energy source to the dispenser can furthermore be provided on the cartridge.

In a further, preferred embodiment of the invention, the cartridge for coupling to a dispenser, positionable in the interior of a household appliance, for delivering at least one washing- and/or cleaning-agent preparation comprises at least one chamber for stocking at least one flowable or pourable washing- and/or cleaning-agent preparation, the cartridge being, in the state coupled with the dispenser, protected from the entry of washing water into the chamber(s), and the cartridge encompassing at least one delivery opening, on the bottom side in the direction of gravity, for (in particular, gravity-effected) delivery of preparation out of at least one chamber, and encompassing at least one vent opening, on the bottom side in the direction of gravity, for venting at least one chamber, the vent opening being separated from the delivery opening (5) and the vent opening being communicatingly connected to at least one chamber of the cartridge.

It is particularly preferred for the cartridge to encompass at least two chambers, very particularly preferably at least three chambers. It is advantageous here that one ventilation orifice and one release orifice are respectively provided for each chamber.

It is furthermore preferred that the bottom-side vent opening be connected communicatingly to a vent conduit whose end facing away from the vent opening terminates, when the cartridge coupled to the dispenser is in the delivery position, above the maximum fill level of the cartridge.

It is advantageous in this context that the vent conduit is shaped entirely or partly into or onto the walls and/or webs of the cartridge. In particular, the vent conduit can be shaped integrally into or onto the walls and/or webs of the cartridge.

For this purpose, the vent conduit can advantageously be formed by joining at least two elements forming the cartridge. For example, a vent conduit can be formed by joining a separating web of the cartridge, shaped in the shell-shaped element, to two webs that are arranged on the cartridge element and enclose the separating web.

It is advantageous in this context if the vent conduit is formed by bonding, in particular by welding, a separating web of the cartridge, shaped in the shell-shaped element, to two webs that are arranged on the cartridge element and enclose the separating web.

As an alternative thereto, the vent conduit can also be embodied, for example, as a so-called dip tube.

In order to ensure venting of the cartridge even in an oblique position, for example when the dispenser is placed in the plate receptacle, that the fill level (F) of the cartridge is not present at the vent conduit orifice (83), in an oblique position of up to 45°, when the cartridge is in the unopened, filled state.

It is furthermore advantageous in this context to arrange the vent conduit orifice approximately centeredly on or in the chamber wall of the cartridge top.

In order to ensure functionality, for example, even following a horizontal position of the cartridge, it is advantageous if the vent conduit, and the viscosity of a flowable preparation, are configured in such a way that the preparation is not drawn by capillary forces into the vent conduit when the preparation is present at the vent conduit orifice.

According to a further advantageous embodiment of the invention, a vent chamber is arranged between the vent opening and the vent conduit.

The cartridge can be embodied so that it can be arranged detachably or fixedly in or on the automatic dishwasher or washing machine and/or laundry dryer.

The outlet openings of the chambers of the cartridge, and the inlet openings of the dispenser, are arranged and configured in such a way that they are sequentially connected to one another by pivoting the dispenser and cartridge, in the latched state, into the coupled state.

It is advantageous in particular for the outlet openings of the chambers to be arranged behind one another in a pivoting direction.

It is very particularly preferred for the outlet openings of the chambers to be arranged on a line (L) in a pivoting direction.

It is furthermore advantageous for the outlet openings of the chambers to be at approximately the same distance from one another.

In a further, advantageous embodiment of the invention, the greatest distance of an outlet opening of a chamber from the pivot point (SP) of the cartridge is approximately 0.5 times the cartridge length distance (L).

In particular, at least two chambers of the cartridge can have volumes differing from one another.

Advantageously, the chamber of the cartridge having the greatest volume is at the greatest distance from the pivot point (SP) of the cartridge (1).

In a further embodiment of the invention, the vent opening of a chamber is located, in a pivot direction upon coupling of the cartridge to the dispenser, in each case before an outlet opening of the chamber.

The ratio of the thickness (D) of the cartridge to the length (L) of the cartridge is preferably approximately 1:20. The ratio of the height (H) of the cartridge to the length (L) of the cartridge is preferably approximately 1:1.2.

It is likewise preferred that the vent opening of a cartridge be located, in a pivot direction upon coupling of the cartridge to the dispenser, in each case before an outlet opening of the chamber.

### Light Guide

The cartridge for coupling to a dispenser, for delivering at least one washing- and/or cleaning-agent preparation out of the cartridge into the interior of a household appliance encompasses, in a preferred embodiment of the invention, a light guide, arranged in or on the cartridge, into which a light signal is couplable from outside the cartridge.

In particular, the light guide can be shaped entirely or partly in or on the walls and/or webs of the cartridge.

It is additionally advantageous to embody the light guide integrally in or on the walls and/or webs of the cartridge.

The light guide is preferably made of a transparent plastic material, It is also possible, however, to configure the entire cartridge from a transparent material.

It is preferred that the light guide be suitable for guiding light in the visible region (380 to 780 nm). It is particularly preferable that the light guide be suitable for guiding light in the near infrared region (780 nm to 3000 nm). It is especially preferred that the light guide be suitable for guiding light in the medium infrared region (3.0 μm to 50 μm).

The light signal that can be coupled into the light guide is, in particular, a carrier of information, especially e.g. with reference to the operating state of the dispenser and/or to the fill level of the cartridge.

In a preferable refinement of the invention, the light guide is embodied in such a way that the light signal couplable into the light guide is also couplable back out of the light guide.

It may be advantageous in this context that the light guide is embodied in such a way that the light signal is couplable out at a point on the cartridge that is different from the point at which the light signal is couplable into the cartridge.

Incoupling or outcoupling of the light signal can be realized, in particular, at a prismatically configured edge of the cartridge.

It is also advantageous that the light signal and the light guide are configured in such a way that a light signal visible to a user can be generated at and/or in the cartridge.

Advantageously, the light guide is surrounded at least in portions, entirely or partly, by a material having a lower optical refractive index. In particular, the material having the lower optical refractive index can be a preparation stocked in a chamber of the cartridge.

According to a further embodiment, the light guide can be severed at at least one point in the cartridge, in such a way that preparation can fill the severed point.

### Dispenser

The control unit necessary for operation, a sensor unit, and at least one actuator are integrated into the dispenser. Preferably an energy source is likewise arranged in the dispenser.

The dispenser is preferably made up of a water-spray-protected housing that can prevent the penetration into the interior of the dispenser of sprayed water such as can occur, for example, upon use in an automatic dishwasher.

It is particularly advantageous to encapsulate in particular the energy source, the control unit, and the sensor unit in such a way that the dispenser is substantially water-tight, i.e. the dispenser device is functional even when completely surrounded by liquid. Encapsulation materials that can be used are, for example, multi-component epoxy and acrylate encapsulating compounds such as methacrylate esters, urethane methacrylates and cyanoacrylates, or two-component materials having polyurethanes, silicones, epoxy resins.

An alternative or supplement to encapsulation is represented by enclosure of the components in an appropriately configured moisture-tight housing. A configuration of this kind is further explained in greater detail below.

It is particularly preferred that the dispenser encompass at least one first interface that interacts corresponding interface embodied in or on a water-conveying appliance, in particular a water-conveying household appliance, preferably an automatic dishwasher or washing machine, in such a way that a transfer of electrical energy from the water-conveying appliance to the dispenser is effected.

In an embodiment of the invention, the interfaces are embodied by plug connectors. In a further embodiment, the interfaces can be embodied such that a wireless transfer of electrical energy is brought about.

It is particularly preferred in this context that the interfaces be inductive transmitters or receivers of electromagnetic waves. In particular, for example, the interface of a water-conveying appliance, such as an automatic dishwasher, can be embodied as a transmitter coil operated with alternating current and having an iron core, and the interface of the dispenser as a receiver coil having an iron core.

In an advantageous refinement of the invention, a second interface is embodied respectively on the dispenser and on the water-conveying appliance, for example an automatic dishwasher, for the transfer of electromagnetic signals that represent in particular operating-state, measurement, and/or control information of the dispenser and/or of the water-conveying appliance such as an automatic dishwasher.

Such an interface can, in particular, be embodied in such a way that a wireless transfer of electromagnetic signals is brought about. The wireless transfer of data can be realized, for example, by radio transfer or IR transfer.

In an advantageous refinement of the invention, the dispenser for delivering at least one washing- and/or cleaning-agent preparation from a cartridge into the interior of a household appliance comprises a light source by means of which a light signal is couplable into a light guide of the cartridge. The light source can be, in particular, an LED.

It is further possible for the light signal that is coupled into the light guide of the cartridge, and that passes through the light guide, to be capable of being sensed by a sensor present on the dispenser.

In a further, advantageous embodiment of the invention, the dispenser for delivering at least one flowable washing- and/or cleaning-agent preparation into the interior of a household appliance encompasses a cartridge couplable with the dispenser, the cartridge stocking at least one flowable washing- and/or cleaning-agent preparation and the cartridge comprising, at the bottom in the direction of gravity, at least one outlet opening that, in the state coupled with the dispenser, is connected communicatingly to an inlet opening of the dispenser, the dispenser and the cartridge comprising means which interact in such a way that a detachable latching engagement is producible between the dispenser and cartridge, the dispenser and cartridge being, in the latched state, pivotable with respect to one another about a pivot point (SP); and that the outlet opening of the cartridge and the inlet opening of the dispensing bracket be configured such that they are connected communicatingly, once latching has been established between the cartridge and dispenser, by pivoting the cartridge into the coupled state between the dispensing bracket and cartridge.

In particular, it is preferred that the outlet openings of the chambers and the inlet openings of the dispenser be arranged and configured in such a manner that they become sequentially connected to one another by pivoting the dispenser and cartridge, in the latched state, into the coupled state.

It is particularly preferred that the inlet openings of the dispenser be respectively arranged behind one another in a pivoting direction.

It is very particularly preferred that the outlet openings of the dispenser be arranged on a line (L) in a pivoting direction.

The inlet openings of the dispenser can also, in particular, be at approximately the same distance from one another.

According to a further advantageous embodiment, means can be embodied on the dispenser and/or the cartridge which, in the coupled state of the dispenser and cartridge, bring about detachable fastening of the cartridge to the dispenser.

It is also advantageous to embody on the dispenser and/or cartridge means which, with the cartridge and dispenser in the latched state, bring about guidance of the cartridge upon pivoting into the coupled state of the cartridge and dispenser.

### Component Carrier

The dispenser encompasses a component carrier on which are arranged at least the actuator and the closure element, as well as the energy source and/or control unit and/or sensor unit and/or dispensing chamber.

The component carrier comprises receptacles for the aforesaid components, and/or the components are shaped in one piece with the component carrier.

The receptacles for the components in the component carrier can be provided for a frictionally engaged, positive, and/or intermaterial connection between a respective component and the corresponding receptacle.

It is further conceivable that for easy removal of the components from the component carrier, the dispensing chamber, actuator, closure element, energy source, control unit, and/or sensor unit are arranged detachably on the component carrier.

It is also advantageous that the energy source, control unit, and sensor unit are arranged on or in the component carrier in a manner grouped into one subassembly. In an advantageous refinement of the invention, the energy source, control unit, and sensor unit are grouped together into one subassembly. This can be realized, for example, by the fact that the energy source, control unit, and sensor unit are arranged on a shared electrical circuit board.

According to a further preferred embodiment of the invention, the component carrier is embodied in trough-shaped fashion, produced as an injection-molded part. It is particularly preferred that the dispensing chamber be embodied in one piece with the component carrier.

The component carrier makes possible, to a very large extent, simple automatic population with the necessary components of the dispenser. The component carrier can thus be preassembled in its entirety, preferably automatically, and joined to a dispenser.

The trough-shaped component carrier can be closed off after population, in liquid-tight fashion, by a cover-like element. The cover-like element can be embodied, for example, as a film that is bonded and in liquid-tight fashion to the component carrier and fauns, with the trough-like component carrier, one or more liquid-tight chambers. The cover-like element can also be a bracket into which the component carrier is introducible, the component carrier and bracket interacting, in the assembled state, in such a way that a liquid-tight connection is embodied between the component carrier and the bracket.

It is further preferred that when the dispenser is in the utilization position, the receptacle for the actuator on the component carrier be arranged above the dispensing chamber in the direction of gravity, thereby allowing a compact conformation of the dispenser to be realized. The compact design can be further optimized by the fact that when the dispenser is in the utilization position, the dispensing chamber inlet on the component carrier is arranged above the receptacle of the actuator. It is also preferable that the components on the component carrier be arranged substantially in line with one another, in particular along the longitudinal axis of the component carrier.

In a refinement of the invention, the receptacle for the actuator comprises an opening that lies on a line with the dispensing chamber outlet, so that a closure element can be moved by the actuator back and forth through the opening and the dispensing chamber outlet.

### Actuator

An “actuator” for purposes of this Application is an apparatus which converts an input variable into an output variable of a different nature, and with which an object is moved or motion thereof is generated, the actuator being coupled to at least one closure element in such a way that the release of preparation from at least one cartridge chamber can be brought about indirectly or directly.

The actuator can be driven by drive systems selected from the group of the gravity drives, ionic drives, electric drives, motor drives, hydraulic drives, pneumatic drives, gear drives, threaded spindle drives, ball screw drives, linear drives, roller screw drives, worm drives, piezoelectric drives, chain drives, and/or reaction drives.

The actuator can be embodied in particular from an electric motor which is coupled to a linkage that converts the rotary motion of the motor into a linear motion of a carriage coupled to the linkage. This is advantageous in particular in the case of a slender, plate-shaped embodiment of the dispensing unit.

There can be arranged on the actuator at least one magnet element that, with a magnet element of identical polarity on a dispenser, brings about a product delivery from the container as soon as the two magnet elements are positioned opposite one another in such a way that a magnetic repulsion of the identically polarized magnet elements is brought about, and a non-contact release mechanism is realized.

In a particularly preferred embodiment of the invention, the actuator is a bistable solenoid that, together with a closure element that engages into the bistable solenoid and is embodied as a plunger core, forms a pulse-controlled bistable valve. Bistable solenoids are electromechanical magnets having a linear motion direction, such that the plunger core locks in unenergized fashion in each end position.

Bistable solenoids or bistable valves are known in the existing art. A bistable valve requires one pulse for the change in valve position (open/closed), and then remains in that position until a counter-pulse is sent to the valve. The term “pulse-controlled valve” is therefore also used. An essential advantage of such pulse-controlled valves is that they consume no energy in order to remain in the valve end positions (closure position and delivery position), but require an energy pulse only in order to change the valve position; the valve end positions may thus be regarded as stable. A bistable valve remains in the switched position that most recently received a control signal.

The closure element (plunger core) is shifted into one end position by a current pulse. The current is switched off and the closure element retains its position. The closure element is shifted into the other end position by a current pulse. The current is switched off and the closure element retains its position.

A bistable property can be implemented in solenoids in various ways. On the one hand, splitting of the coil is known. The coil is split more or less centeredly, thus creating a gap. A permanent magnet is inserted into this gap. The plunger core itself is machined down at both the front and back so that it has, in each end position, a surface abutting in planar fashion with respect to the magnet frame. The magnetic field of the permanent magnet flows via this surface and the plunger core adheres here. Another alternative possibility is the use of two separate coils. The principle is similar to that of the bistable solenoid having a split coil. The difference is that electrically, there are in fact two different coils. Control is applied to them separately from one another, depending on the direction in which the plunger core is to be moved.

### Closure Element

A “closure element” for purposes of this Application is a component on which the actuator acts and which, as a consequence of that action, brings about opening or closure of an outlet opening.

The closure element can involve, for example, valves that can be brought by the actuator into a product delivery position or a closure position.

Embodiment of the closure element and the actuator in the form of a solenoid valve, in which the metering unit is embodied by the valve and the actuator by the electromagnetic or piezoelectric drive system of the solenoid valve, is particularly preferred. Especially when a plurality of containers, and thus of preparations to be dispensed, are used, the use of solenoid valves allows the dispensed quantity and dispensing times to be regulated very accurately.

It is therefore advantageous to control the delivery of preparations out of each outlet opening of a chamber using a solenoid valve, by the fact that the solenoid valve indirectly or directly determines the release of preparation out of the product delivery opening.

### Sensor

A “sensor” for purposes of this Application is a measured variable transducer or sensing element that can sense specific physical or chemical properties and/or the material nature of its environment, qualitatively or, as a measured variable, quantitatively.

The dispensing unit preferably comprises at least one sensor that is suitable for sensing a temperature. The temperature sensor is embodied in particular for sensing a water temperature.

It is further preferred that the dispensing unit encompass a sensor for sensing conductivity, with which, in particular, the presence of water or the spraying of water, in particular in an automatic dishwasher, is sensed.

In a refinement of the invention, the dispensing unit comprises a sensor that can determine physical, chemical, and/or mechanical parameters from the environment of the dispensing unit. The sensor unit can encompass one or more active and/or passive sensors for qualitative and/or quantitative sensing of mechanical, electrical, physical, and/or chemical variables, which are conveyed as control signals to the control unit.

The sensors of the sensor unit can be selected, in particular, from the group of the timers, temperature sensors, infrared sensors, brightness sensors, temperature sensors, motion sensors, elongation sensors, rotation speed sensors, proximity sensors, flow sensors, color sensors, gas sensors, vibration sensors, pressure sensors, conductivity sensors, turbidity sensors, acoustic pressure sensors, “lab on a chip” sensors, force sensors, acceleration sensors, tilt sensors, pH sensors, moisture sensors, magnetic field sensors, REID sensors, magnetic field sensors, Hall sensors, biochips, odor sensors, hydrogen sulfide sensors, and/or MEMS sensors.

Especially in the case of preparations whose viscosity fluctuates greatly as a function of temperature, it is advantageous in terms of monitoring the volume or mass of the dispensed preparations to provide flow sensors in the dispensing apparatus. Suitable flow sensors can be selected from the group of the diaphragm flow sensors, magnetic induction flow meters, mass flow measurement using the Coriolis method, vortex meter flow measurement methods, ultrasonic flow measurement methods, suspended solid particle flow measurement, oscillating piston flow measurement, thermal mass flow measurement, or differential pressure flow measurement.

It is also conceivable for a temperature-dependent viscosity curve of at least one preparation to be stored in the control unit, the dispensing action being adapted by the control unit in accordance with the temperature and thus the viscosity of the preparation.

In a further embodiment of the invention, an apparatus for directly determining the viscosity of the preparation is provided.

The alternatives set forth above for determining the dispensed quantity or viscosity of a preparation serve to generate a control signal that is processed by the control unit to control a metering unit, in such a way that substantially constant dispensing of a preparation is brought about.

The data line between the sensor and control unit can be realized by way of an electrically conductive cable, or wirelessly.

A wirelessly embodied data line is embodied in particular by the transfer of electromagnetic waves. It is preferred to embody a wireless data line in accordance with accepted standards such as, for example, Bluetooth, IrDA, IEEE 802, GSM, UMTS, etc.

In a particularly preferred embodiment of the invention, the sensor is arranged at the bottom of the dispenser, the bottom of the dispenser being directed, in the utilization position, downward in the direction of gravity. It is particularly preferred in this context that the sensor unit encompass a temperature sensor and/or a conductivity sensor. A configuration of this kind ensures that water is conveyed by the spray arms of the dishwasher onto the underside of the dispenser and thus brought into contact with the sensor. Because the distance between the spray arms and the sensor is as short as possible as a result of the bottom-side arrangement of the sensor, the water experiences only slight cooling between emergence at the spray arms and contact with the sensor, so that a maximally accurate temperature measurement can be carried out.

### Control Unit

A “control unit” for purposes of this Application is an apparatus that is suitable for influencing the transportation of material, energy, and/or information. For this purpose, the control unit influences actuators with the aid of data, in particular measurement signals of the sensor unit, which it processes as defined by the control objective.

The control unit can be in particular a programmable microprocessor. In a particularly preferred embodiment of the invention, a plurality of dispensing programs, which in can be selected and executed in a manner corresponding to the container coupled to the dispenser, are stored on the microprocessor.

In a preferred embodiment, the control unit has no connection to the household appliance control system that is possibly present. No data, in particular electrical or electromagnetic signals, are therefore exchanged directly between the control unit and the household appliance control system.

In an alternative embodiment of the invention, the control unit is coupled to the household appliance control system that is present. This coupling is preferably embodied wirelessly. It is possible, for example, to position a transmitter on or in an automatic dishwasher, preferably on or at the dispensing chamber recessed into the door of the automatic dishwasher, which transmitter wirelessly transfers a signal to the dispensing unit when the household appliance control system brings about dispensing, for example, of a cleaning agent out of the dispensing chamber, or of rinse aid.

Multiple programs for the release of different preparations, or for the release of products in different application instances, can be stored in the control unit.

In a preferred embodiment of the invention, invocation of the corresponding program can be brought about by way of corresponding RFID labels, or geometric information carriers shaped on the container. For example, it is possible to use the same control unit for a plurality of applications, for example to dispense cleaning agents in automatic dishwashers, to deliver perfumes in the context of room scenting, to apply cleaning substances into a toilet bowl, etc.

For the dispensing of, in particular, preparations that tend to gel, the control unit can be configured in such a way that on the one hand dispensing occurs in a sufficiently short time to ensure a good cleaning result, and on the other hand the preparation is not dispensed so quickly that gelling of the surge of preparation occurs. This can be achieved, for example by way of an interval-type release, the individual dispensing intervals being adjusted so that they completely trigger the correspondingly dispensed quantity during one cleaning cycle.

The delivery of preparations out of the dispenser can occur sequentially or simultaneously.

### Energy Source

For purposes of this Application, an “energy source” is understood as a component of the dispensing system that is useful for making available energy suitable for operation of the dispensing system or the dispenser. The energy source is preferably configured in such a way that the dispensing system is autonomous.

The energy source preferably makes available electrical energy. The energy source can be, for example, a battery, a rechargeable battery, a power supply, solar cells, or the like.

It is particularly advantageous to embody the energy source exchangeably, for example in the form of a replaceable battery.

A battery can be selected, for example, from the group of the alkaline manganese batteries, zinc-carbon batteries, nickel-oxyhydroxide batteries, lithium batteries, lithium-iron sulfide batteries, zinc-air batteries, zinc chloride batteries, mercury oxide-zinc batteries, and/or silver oxide-zinc batteries.

Suitable as rechargeable batteries are, for example, lead batteries (lead dioxide/lead), nickel-cadmium batteries, nickel-metal hydride batteries, lithium ion batteries, lithium polymer batteries, alkaline manganese rechargeable batteries, silver-zinc rechargeable batteries, nickel hydride batteries, zinc-bromine batteries, sodium-nickel chloride batteries, and/or nickel-iron batteries.

The rechargeable battery can be configured in particular so that it can be recharged by induction.

It is also conceivable, however, to embody mechanical energy sources made up of one or more helical springs, torsional or torsion-bar springs, flexural springs, air springs or gas-pressure springs, and/or elastomer springs.

The energy source is dimensioned in such a way that the dispenser can execute approximately 300 dispensing cycles before the energy source is depleted. It is particularly preferred that the energy source be capable of executing between 1 and 300 dispensing cycles, very particularly preferably between 10 and 300, more preferably between 100 and 300, before the energy source is depleted.

In addition, means for energy conversion can be provided in or on the dispensing unit, which means generate a voltage with which the rechargeable battery is charged. These means can be embodied, for example, as a dynamo that is driven by water flows during a washing cycle in a dishwasher, and that delivers to the rechargeable battery the voltage thus generated.

### Vibratory Atomizer

In a further preferred embodiment of the invention, the dispensing system comprises at least one vibratory atomizer, by means of which it is possible to convert a preparation into, or keep it in, the gas phase. It is thus conceivable, for example, to use the vibratory atomizer to vaporize, nebulize and/or atomize preparations, with the result that the preparation transitions into the gas phase or forms an aerosol in the gas phase, the gas phase usually being air.

This embodiment is particularly advantageous for use in an automatic dishwasher or washing machine in which corresponding release of preparation into the gas phase takes place in a closable washing compartment. The preparation introduced into the gas phase can become uniformly distributed in the washing compartment, and become deposited on the items to be washed that are located in the automatic dishwasher.

The preparation released by the vibratory atomizer can be selected from the group of the surfactant-containing preparations, enzyme-containing preparations, odor-neutralizing preparations, biocidal preparations, and antibacterial preparations.

As a result of application of the cleaning preparations from the gas phase onto the items being washed, a uniform layer of the corresponding cleaning preparation is applied onto the surface of the items being washed. It is particularly preferable for the entire surface of the items being washed to be wetted by the cleaning preparation.

A number of advantageous effects may thereby be achieved before the start of a water-releasing cleaning program of the automatic dishwasher. On the one hand, a suitable cleaning preparation can suppress the creation of unpleasant odors as a result of biological decomposition processes taking place in food residues adhering to the items being washed. On the other hand, an appropriate cleaning preparation can “soften” the food residues that may possibly be adhering to the items being washed, so that they can be easily and completely detached during the dishwasher cleaning program, in particular in the case of low temperature programs.

It is additionally possible to apply a preparation by means of the vibratory atomizer onto the items being washed after an automatic dishwasher cleaning program has ended. This can involve, for example, a preparation having antibacterial action or a preparation for modifying surfaces.

### APPLICATION EXAMPLES

In principle, the dispensing system of the kind described above is suitable for use in or in conjunction with water-conveying apparatuses of any kind.

The dispensing system according to the present invention is suitable in particular for use in water-conveying household appliances such as automatic dishwashers and/or washing machines, but is not limited to such use.

In general, it is possible to use the dispensing system according to the present invention wherever dispensing of at least one, preferably multiple preparations into a liquid medium, in accordance with an external physical or chemical parameter that triggers or controls a dispensing program, is required.

It is thus also conceivable, for example, to use the dispensing system in household robots, such as for example automatic floor cleaning machines, for dispensing cleaning substances into a toilet bowl or toilet flushing tank, in water-conveying cleaning devices such as, for example, pressure washers, in window-washing systems for vehicles, plant watering systems, steam ironing devices, valves, and the like.

### Description of Illustrations

FIG. 1 shows, in the separated and the assembled state, an autonomous dispenser 2 having a two-chamber cartridge 1.

Dispenser 2 comprises two dispensing chamber inlets 21a, 21b for repeatedly detachable reception of the corresponding outlet openings 5a, 5b of chambers 3a, 3b of cartridge 1. Located on the front side are indicating and control elements 37 that indicate the operating state of dispenser 2 or act on it.

Dispensing chamber inlets 21a, 21b further comprise means that, upon placement of cartridge 1 onto dispenser 2, cause outlet openings 5a, 5b of chambers 3a, 3b to open, so that the interior of chambers 3a, 3b is communicatingly connected to dispensing chamber inlets 21a, 21b.

Cartridge 1 can be made up of one or more chambers 3a, 3b. Cartridge 1 can be embodied in one piece with multiple chambers 3a, 3b, or in multiple pieces, the individual chambers 3a, 3b then being joined together into a cartridge 1 in particular by means of intermaterial, positive, or frictionally engaged connecting methods.

Fastening can be accomplished, in particular, by means of one or more connection types from the group of the snap-in connections, press connections, melt connections, adhesively bonded connections, weld connections, solder connections, screw connections, keyed connections, clamped connections, or flip-closure connections. Fastening can, in particular, be embodied by a heat-shrink sleeve, which in a heated state is pulled over at least portions of the cartridge, and in the cooled state fixedly surrounds the cartridge.

In order to provide advantageous residual emptying properties for cartridge 1, the bottom of cartridge 1 can be inclined in the manner of a funnel toward delivery opening 5a, 5b. Moreover, the inner wall of cartridge I can be embodied, by suitable material selection and/or surface configuration, in such a way that little adhesion of material onto the internal cartridge wall occurs. This feature, too, allows the residual emptying capability of cartridge 1 to be further optimized.

Chambers 3a, 3b of cartridge 1 can have volumetric capacities that are identical or are different from one another. In the case of a configuration having two chambers 3a, 3b, the ratio of the chamber volumes is preferably 5:1, in the case of a configuration having three chambers preferably 4:1:1, these configurations being suitable in particular for use in automatic dishwashers.

One connection method can also consist in plugging chambers 3a, 3b into one of the corresponding dispensing chamber inlets 21a, 21b of dispenser 2, and thereby fastening them with respect to one another.

The connection between chambers 3a, 3b can in particular be embodied detachably, in order to permit separate replacement of a chamber.

Chambers 3a, 3b each contain a preparation 40a, 40b. Preparations 40a, 40b can have identical or different compositions.

Advantageously, chambers 3a, 3b are produced from a transparent material so that the fill level of preparations 40a, 40b is visible to the user from outside. It may also be advantageous, however, to produce at least one of the chambers from an opaque material, especially if the preparation present in that chamber contains light-sensitive ingredients.

Outlet openings 5a, 5b are configured so that they embody, with the corresponding dispensing chamber inlets 21a, 21b, a positive and/or frictionally engaged, in particular liquid-tight, connection.

It is particularly advantageous that each of the outlet openings 5a, 5b is embodied so that it fits onto only one of the dispensing chamber inlets 21a, 21b, thereby preventing a chamber from being inadvertently put onto an incorrect dispensing chamber inlet.

Cartridge 1 usually has a volumetric capacity of <5000 ml, in particular <1000 ml, preferably <500 ml, particularly preferably <250 ml, very particularly preferably <50 ml.

In the assembled state, dispensing unit 2 and cartridge 1 can be adapted in particular to the geometries of the appliances on or in which they are utilized, so as to ensure the least possible loss of useful volume. To use dispensing unit 2 and cartridge 1 in automatic dishwashers, it is particularly advantageous to shape dispensing unit 2 and cartridge 1 by analogy with tableware to be cleaned in automatic dishwashers. Dispensing unit 2 and cartridge 1 can thus, for example, be plate-shaped, having approximately the dimensions of a dinner plate. As a result, the dispensing unit can be positioned in space-saving fashion in the lower rack.

In order to provide a direct visual check of the fill level, it is advantageous to shape cartridge 1 at least in portions from a transparent material.

In order to protect heat-sensitive constituents of a product present in a cartridge from the effect of heat, it is advantageous to manufacture cartridge 1 from a material having low thermal conductivity.

Outlet openings 5a, 5b of cartridge 1 are preferably arranged on a line or in alignment, thus enabling a slender, plate-shaped embodiment of the dispensing metering unit.

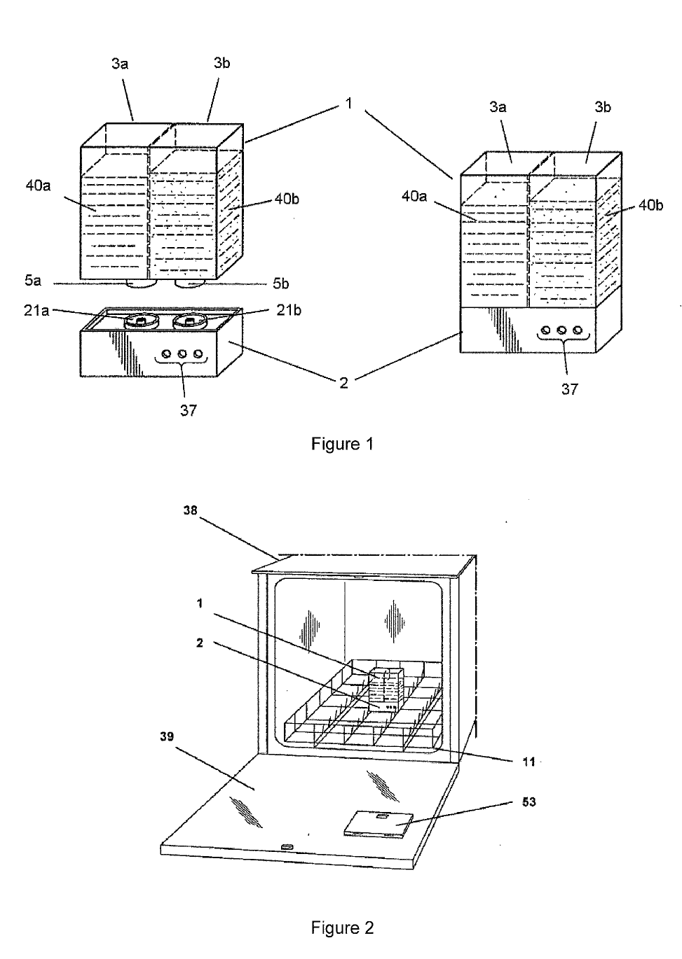

FIG. 2 shows an autonomous dispenser having a two-chamber cartridge 1 in dishwasher drawer 11, the automatic dishwasher door 39 of an automatic dishwasher 38 being open.

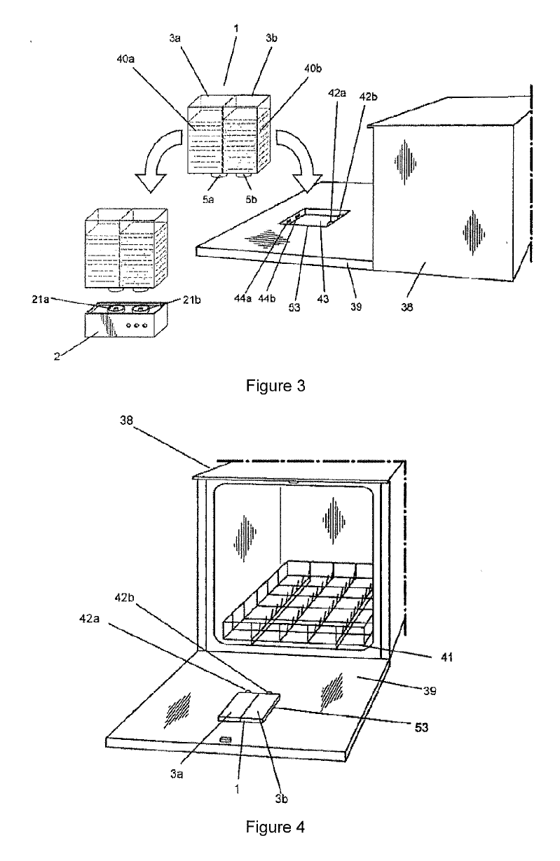

FIG. 3 shows a two-chamber cartridge 1 separated into an autonomous dispenser 2 and an internal, machine-integrated dispenser. Cartridge 1 is embodied in this context in such a way that it is couplable both to autonomous dispenser 2 and to the machine-integrated dispenser (not depicted); this is indicated by the arrows depicted in FIG. 3.

Shaped onto that side of automatic dishwasher door 39 which is directed toward the interior of automatic dishwasher 38 is a depression 43 into which cartridge 1 can be inserted, outlet openings 5a, 5b of cartridge 1 being, as a result of the insertion, communicatingly connected to adapter pieces 42a, 42b. Adapter pieces 42a, 42b are in turn coupled to the machine-integrated dispenser.

In order to fasten cartridge 1 in depression 43, holding elements 44a, 44b that ensure frictionally engaged and/or positive fastening of the cartridge in depression 43 are provided on depression 43. It is of course also conceivable for corresponding holding elements to be provided on cartridge 1. Holding elements 44a, 44b can preferably be selected from the group of the snap connections, latch connections, snap/latch connections, clamped connections, or plug connections.

During the operation of automatic dishwasher 38, preparation 40a, 40b is conveyed by the machine-integrated dispenser out of cartridge 1 and through adapter elements 42a, 42b to the corresponding washing cycle.

FIG. 4 shows cartridge 1, known from FIG. 3, as installed in door 39 of an automatic dishwasher 38.

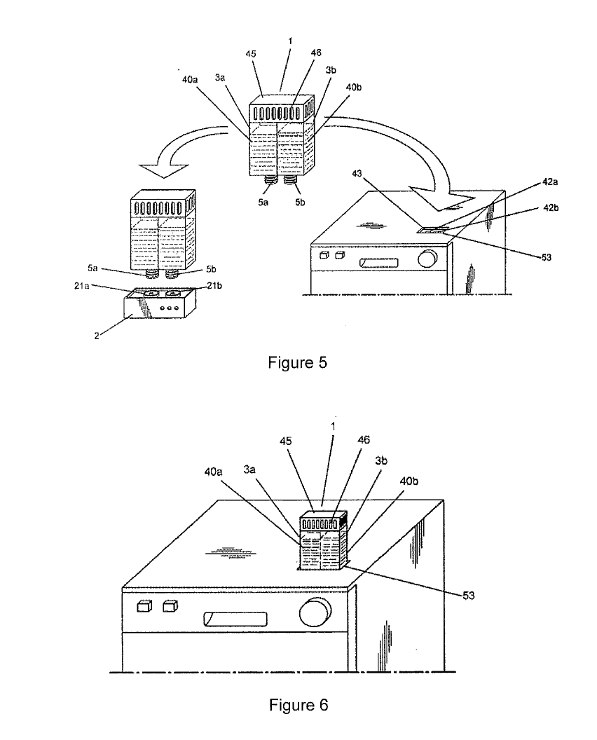

A further embodiment of the invention is illustrated in FIG. 5. FIG. 5 shows cartridge 1, known from FIG. 3, with a chamber 45 that is arranged at the top of cartridge 1 and comprises in its enveloping surface a plurality of openings 46. Chamber 45 is preferably filled with an air freshening preparation that is delivered through openings 46 to the environment. The air freshening preparation can encompass, in particular, at least one scent and/or one odor-counteracting substance.

In contrast to the arrangement as known from FIG. 3 and FIG. 4 of cartridge 1 in the interior of an automatic dishwasher 1, it is also possible to provide a depression 43, having adapter elements 42a, 42b for coupling to cartridge 1, on an outer surface of an automatic dishwasher 38. This is depicted by way of example in FIG. 5 and FIG. 6.

Cartridge 1 illustrated in FIG. 5 and FIG. 6 can of course also be arranged, with a chamber 45 containing an air freshening substance, in a correspondingly embodied receptacle in the interior of an automatic dishwasher 38.

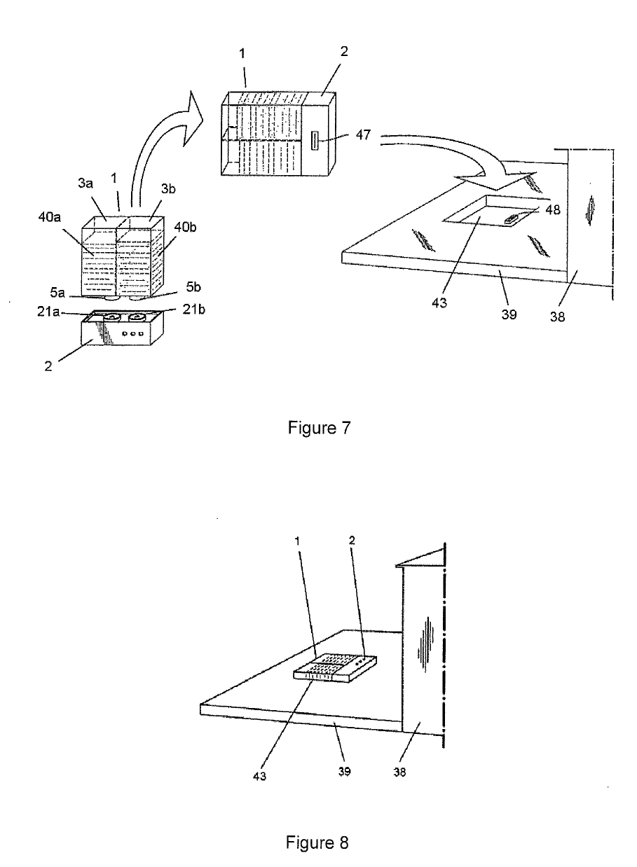

A further embodiment of the invention is shown in FIG. 7. Here dispenser 2 can be coupled to cartridge 1, as correspondingly indicated by a first arrow on the left in the drawing. Cartridge 1 and dispenser 2 are then coupled as one subassembly, via interface 47, 48, to the dishwasher, as indicated by the arrow on the right. Dispenser 2 comprises an interface 47 through which data and/or energy are transferred to and/or from dispenser 2. A depression 43 for the reception of dispenser 2 is provided in door 39 of dishwasher 38. Provided in depression 43 is a second interface 48 that transfers data and/or energy to and/or from dispenser 2.

Data and/or energy are preferably exchanged wirelessly between first interface 47 on dispenser 2 and second interface 48 on dishwasher 38. It is particularly preferred that energy be transferred from interface 48 of dishwasher 38 wirelessly via interface 47 to dispenser 2. This can occur, for example, inductively and/or capacitively.

It is further advantageous also to configure the interface for the transfer of data wirelessly. This can be achieved using methods known in the existing art for the wireless transfer of data, for example by radio transfer or IR transfer.

Alternatively, interfaces 47, 48 can also be embodied by means of integrated plug connections. Advantageously, the plug connections are embodied in such a way that they are protected from the penetration of water or moisture.

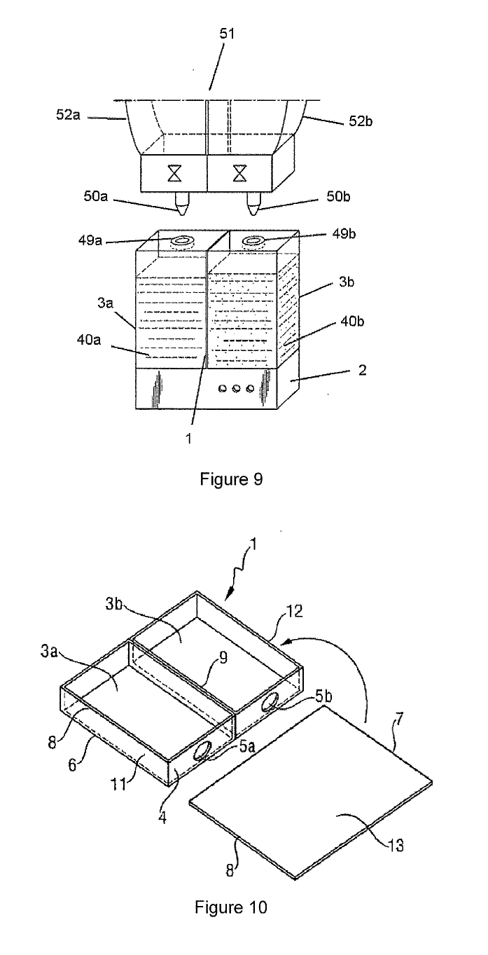

FIG. 9 shows a cartridge 1 whose chambers 3a, 3b are fillable via the top-side openings 49a, 49b, for example by means of a refill cartridge 51. Openings 49a, 49b of cartridge 1 can be embodied, for example, as silicone slit valves that open upon penetration by adapter 50a, 50b and close again upon removal of adapter 50a, 50b, thereby preventing unintentional outflow of preparation from the cartridge.

Adapters 50a, 50b are embodied in such a way that they can penetrate openings 49a, 49b of cartridge 1. Advantageously, openings 49a, 49b of cartridge 1, and adapter 50a, 50b, are configured in terms of their position and size in such a way that the adapter can engage into openings 49a, 49b only in one predefined position. This allows, in particular, incorrect filling of cartridge chambers 3a, 3b to be prevented, and ensures that the respectively identical or compatible preparation travels out of a chamber 52a, 52b of refill cartridge 51 into the corresponding chamber 3a, 3b of cartridge 1.

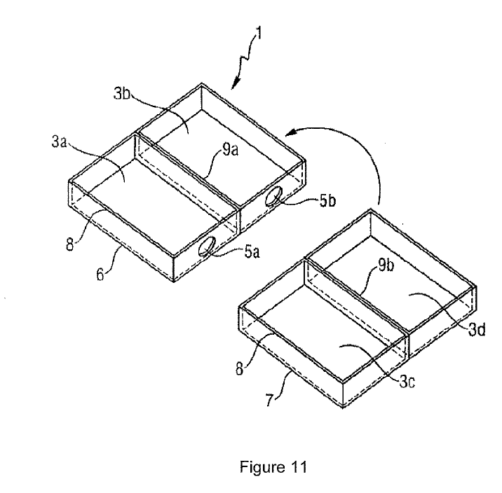

Further exemplifying embodiments of the cartridge known from the previous illustrations are shown in FIG. 10 to FIG. 16.

In a first embodiment that is reproduced in FIG. 10, cartridge 1 is made up of a first trough-shaped element 6 and a second plate- or cover-like element 7; FIG. 10 shows the two elements 6, 7 in the unassembled state. The second plate- or cover-like element 7 is dimensioned so that when cartridge 1 is in the assembled state, the element completely covers first trough-shaped element 6 along connecting edge 8.

First trough-shaped element 6 is formed by cartridge top 10, cartridge side surfaces 11 and 12, and cartridge bottom 4. The two chambers 3a, 3b of cartridge 1 are defined by separating web 9. A respective outlet opening 5a, 5b is provided on cartridge bottom 4 for each of the chambers 3a, 3b. Cartridge 1 is formed by bonding of first trough-shaped element 6 to second plate- or cover-like element 7.

A further possible configuration of the cartridge is shown by FIG. 11, in which two cartridge elements 6, 7 are once again visible in the not-yet-assembled state. The two cartridge elements 6, 7 are embodied mirror-symmetrically, so that in the assembled state the connecting edges 8 of the two elements 6, 7 rest completely on one another. Outlet openings 5a and 5b are embodied only on bottom 4 of first cartridge element 6, so that connecting edge 8 of elements 6, 7 on cartridge bottom 4 extends outside outlet openings 5a, 5b, and connecting edge 8 therefore does not intersect outlet openings 5a, 5b. More reliable sealing of outlet openings 5a, 5b can thereby be ensured, since material deformations in the region of outlet openings 5a, 5b, in particular because of thermal loads, are more uniform, and an abutting or connecting edge 8 does not result in an inhomogeneous deformation that can subsequently result in undesirable sealing problems.

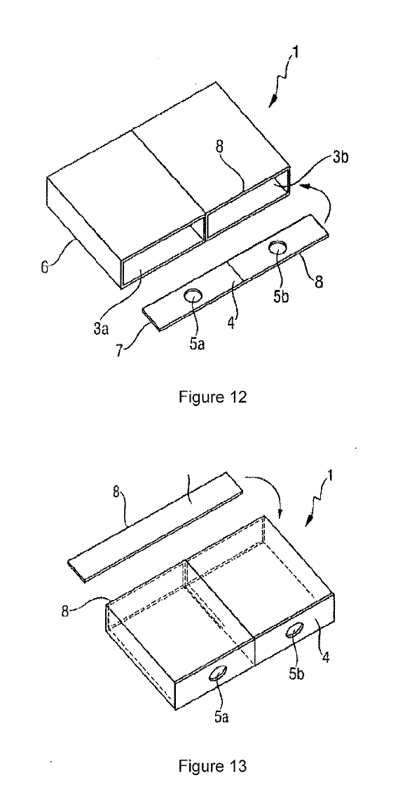

FIG. 12 shows a variant of the cartridge known from FIG. 10 and FIG. 11. In this embodiment, first cartridge element 6 is configured as a one-piece cell-shaped bottomless plastic container. Cartridge 1 is formed by fitting bottom 4 onto container 6 along connecting edge 8, as indicated by the arrow in the Figure. Bottom 4 comprises a first opening 5a and a second opening 5b which, when cartridge 1 is in the assembled state, permit preparation to flow out of the respective chambers 3a, 3b.

As an alternative thereto, it is also conceivable for a cartridge element 6 to be embodied as a cell-like container open at the top and having chambers 3a, 3b, and the second element as cartridge cover 10 that is connected to the cell-like container open at the top, in liquid-tight fashion, along connecting edge 8, as is evident from FIG. 13.

FIG. 14 illustrates the fact that cartridge 1 can be formed from two chambers 3a, 3b shaped separately from one another. In this variant embodiment, the two chambers 3a, 3b are bonded, positively, and/or in frictionally engaged fashion to one another, detachably or nondetachably, and thus form cartridge 1.

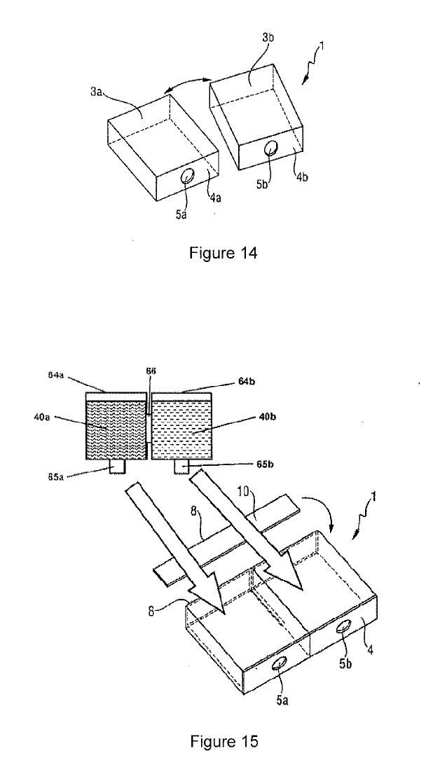

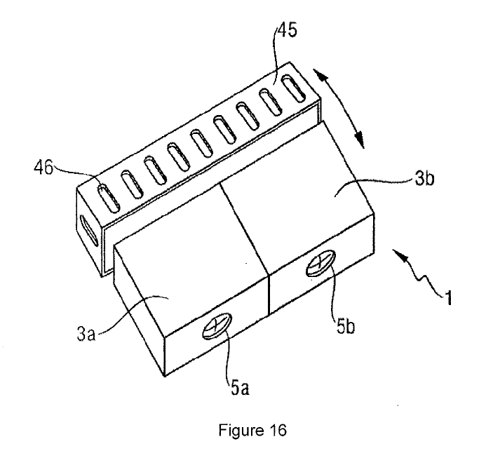

FIG. 15 shows cartridge 1, known from FIG. 13, as a receiving vessel for a pouch 64 filled with preparation 40, so that by insertion of the pouch into the cartridge chambers, as indicated by the arrows in the illustration, a so-called “bag-in-bottle” vessel is embodied. Openings 65a, 65b of pouch 64a, 64b are shaped in such a way that they can be plugged into openings 5a, 5b of cartridge 1. Openings 65a, 65b are preferably shaped as dimensionally stable plastic cylinders. It is on the one hand conceivable for each pouch 64a, 64b to be positioned into a corresponding chamber of cartridge 1, but it is also possible to embody a multichamber pouch, connected via a web 66, that is inserted as a whole into the cartridge.

FIG. 16 shows a refinement of the cartridge known from FIG. 10 to FIG. 14, in which a further chamber 45 for receiving a preparation is arranged on the cartridge and is configured in such a way that a delivery of volatile substances from the preparation into the environment of chamber 45 is brought about.

Chamber 45 can contain, for example, volatile scents or air freshening substances, which are delivered through openings 46 of chamber 45 to the environment.

It is further evident that openings 5a, 5b are closed off by silicone slit valves that have an X-shaped slit.

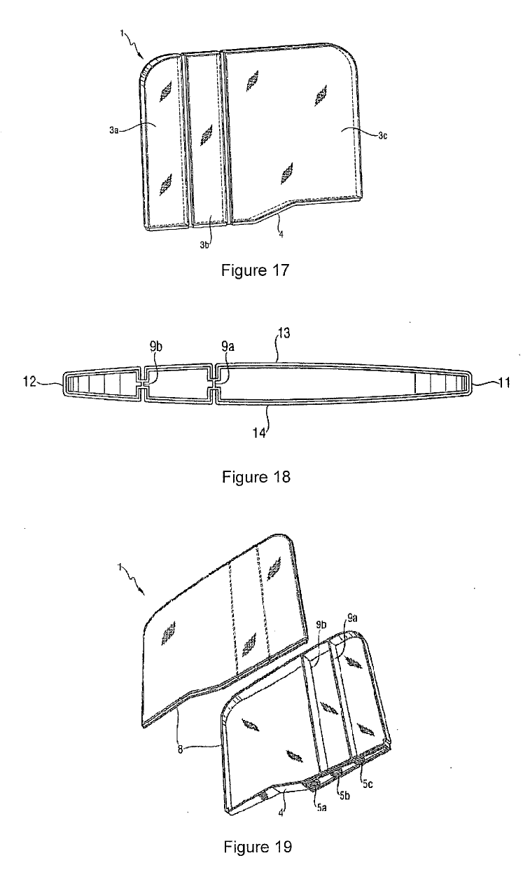

FIG. 17 shows a further possible embodiment of cartridge 1 having three chambers 3a, 3b, 3c. First chamber 3a and second chamber 3b have an approximately identical volumetric capacity. Third chamber 3c has a volumetric capacity that is approximately five times as great as that of one of chambers 3a or 3b. Cartridge bottom 4 comprises a ramp-like step in the region of third chamber 3c. Thanks to this asymmetrical conformation of cartridge 1, it is possible to ensure that cartridge 1 is couplable, in a position provided therefore, with dispenser 2, and to prevent insertion in an incorrect position by way of a corresponding configuration of dispenser 2 or of bracket 54.

The plan view of the cartridge illustrated in FIG. 18 shows separating webs 9a and 9b that separate the chambers of cartridge 1 from one another. The cartridge known from FIG. 17 and FIG. 18 can be formed in various ways.

In a first variant that may be gathered from FIG. 19, cartridge 1 is formed from a first trough-like cartridge element 7 and a second cover- or plate-like cartridge element 6. Shaped in trough-like cartridge element 7 are separating webs 9a and 9b by which the three chambers of cartridge 1 are embodied. Outlet openings 5a, 5b, 5c are arranged on bottom 4 of trough-shaped cartridge element 7, underneath the respective chambers of cartridge 1.

As may further be gathered from FIG. 19, bottom 4 of the cartridge comprises, in the region of third chamber 3c, a ramp-like step that embodies on the chamber bottom a downward slope in the direction of third outlet opening 5c. This ensures that preparation present in this chamber 3c is always directed toward outlet opening 5c, and that good residual emptying characteristics for chamber 3c are thus achieved.

When cartridge 1 is in the assembled state, trough-shaped cartridge element 7 and cover-like cartridge element 6 are bondedy to one another along the shared connecting edge 8. This can be realized, for example, by welding or adhesive bonding. Webs 9a, 9b are of course also bonded to cartridge element 6 when cartridge 1 is in the assembled state.

Connecting edge 8 here does not extend through outlet openings 5a-c; this avoids sealing problems, in particular in the state coupled to the dispenser, in the region of openings 5a-c.

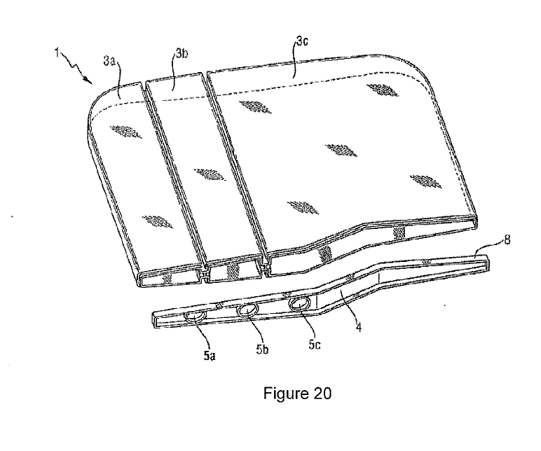

FIG. 20 shows a further embodiment of the cartridge. Here first cartridge element 6 is embodied in cell-like fashion and comprises an open bottom. The separately shaped bottom 4 can be inserted, as a second cartridge element 7, into the bottom-side opening of cell-like cartridge element 6 and bonded along the shared connecting edge 8. The advantage of this variant is that cell-like element 6 can be economically manufactured using a plastic blow-molding method.

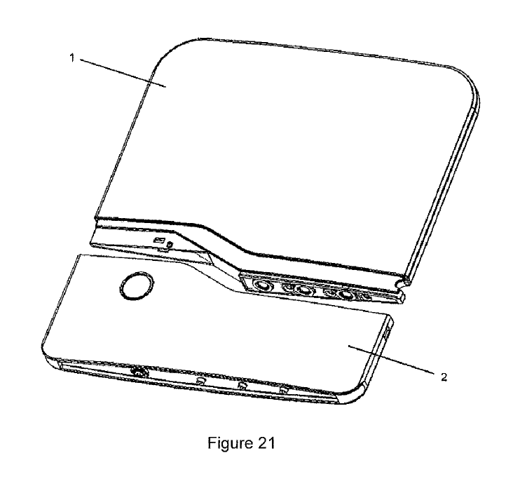

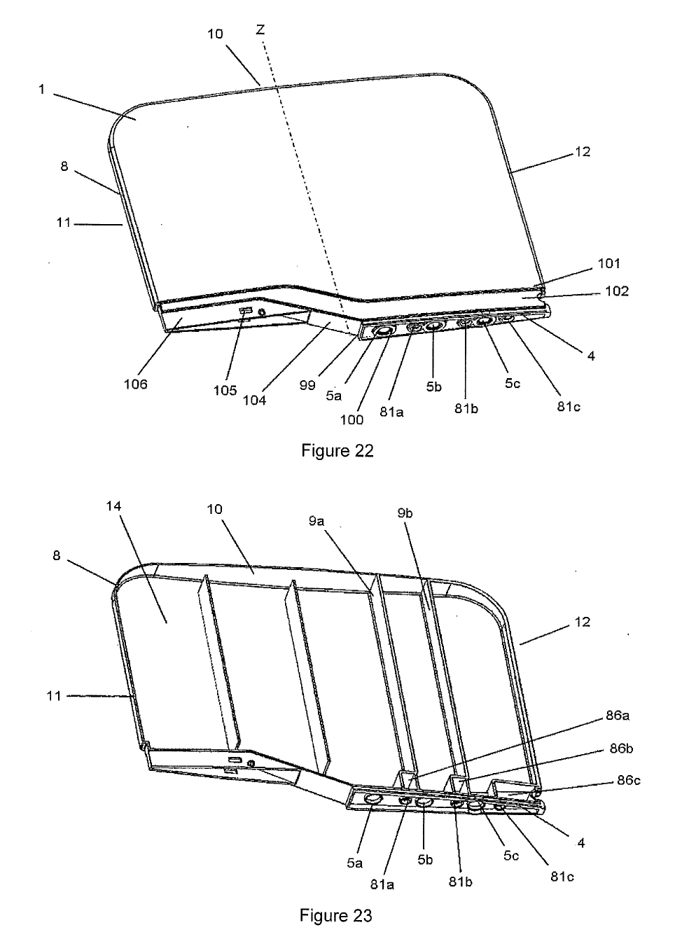

FIG. 21 shows a further embodiment of cartridge 1 and of dispenser 2 in the state not coupled to one another. Cartridge 1 of FIG. 21 will be explained further with reference to FIG. 22.

FIG. 22 is a perspective view of cartridge 1 known from FIG. 21. Outlet and vent openings 5, 81 are arranged, alternatingly with one another, on cartridge bottom 4. One outlet opening 5 and one vent opening 81 is provided for each of the chambers in cartridge 1.

The region of cartridge bottom 4 on which the outlet and vent openings are arranged is surrounded by a peripheral collar 99. This collar 99 on the one hand brings about structural reinforcement of cartridge 1 in the bottom region, which prevents deformation in the bottom region especially upon insertion of cartridge 1, when corresponding applied pressures act on bottom region 4 in order to couple cartridge 1 to dispenser 2, thereby enabling controlled and secure insertion of cartridge 1 into dispenser 2.

Collar 99 further offers protection from undesired mechanical effects on the closures of the outlet and vent openings. As is evident from FIG. 22, outlet and vent openings 5, 81 are set back with respect to collar 99, so that openings 5, 81 are, for example, protected from the direct action of objects that are larger than the openings.

As is further visible in FIG. 22, outlet and vent openings 5, 81 each comprise a collar 100. This collar 100 enclosing outlet and vent openings 5, 81 also serves for structural reinforcement of outlet and vent openings 5, 81 in bottom region 4 of cartridge 1. In addition, collar 100 can serve to strengthen closure means of outlet and vent openings 5, 81, for example closure plugs or closure covers.

Collar 100 of one of outlet and vent openings 5, 81 is set back with respect to collar 99, so that collar 100 does not project above the edge of collar 99.

It may further be gathered from FIG. 22 that cartridge 1 is embodied asymmetrically with regard to its axis Z-Z. The effect of this asymmetry is that cartridge 1 is couplable to dispenser 2, in particular to inlet openings 21 of dispenser 2, in only one defined way. The result is to embody a mechanical lock-and-key principle between cartridge 1 and dispenser 2, preventing incorrect operation upon coupling of cartridge 1 to dispenser 2.

The asymmetry of cartridge 1 is brought about, inter alia, by the fact that bottom 4 comprises two planes, the first plane being formed by collar 99 that encloses outlet and vent openings 5, 81 and the second plane being a bottom segment that is offset via a ramp 104 toward cartridge top 10, as is clearly apparent e.g. in FIG. 22.

Proceeding from ramp 104, there extends from the bottom section of the second plane a further collar 105 that comprises an opening 106. Opening 106 forms, with hook 56 shaped on hinge 55, a detachable latching connection to retain cartridge 1 in the coupled state with dispenser 2.

Also evident FIG. 22 is a peripheral edge 101 in the lower, bottom-side region of cartridge 1. Extending from this edge 101 in the bottom direction is a peripheral wall segment 102 of cartridge 1 that is set back toward the interior of cartridge 1 so that a shoulder extending toward the interior of the cartridge is embodied between edge 101 and wall segment 102.

Dispenser 2 is embodied in such a way that peripheral wall segment 102 can be introduced into collar 103 of dispenser 2; with cartridge 1 and dispenser 2 in the coupled position, edge 101 of the cartridge rests on collar 103 of the dispenser, so that the space surrounded by collar 103 of dispenser 2 is protected at least from the entry of sprayed water. Collar 103 of dispenser 2 and edge 101 of the cartridge can also, in particular, be configured so that with cartridge 1 and dispenser in the coupled state, entry of water into the space of the dispenser surrounded by collar 103 is prevented by a substantially sealing contact of edge 101 on collar 103.

In addition, the inwardly offset wall segment 102 of the cartridge, in conjunction with the dispenser-side collar 103, brings about guidance of cartridge 1 upon insertion into dispenser 2.

Cartridge 1 is formed from two elements that are positively welded to one another at the peripheral connecting edge 8. FIG. 23 shows cartridge 1 known from FIG. 22 with a cover-like element removed along connecting edge 8, so that FIG. 23 provides a view into the interior of cartridge 1.

It is evident that cartridge 1 is subdivided by the two separating webs 9a, 9b into three chambers, each of the chambers having at the bottom, in the direction of gravity, an outlet opening 5.

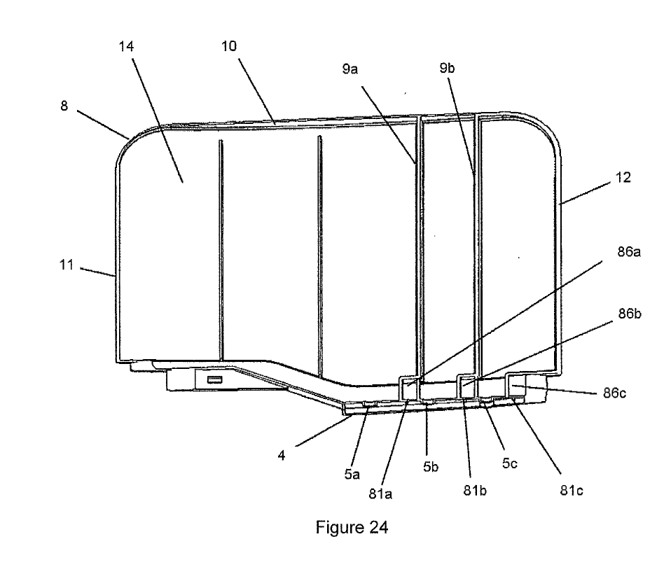

Arranged at the bottom end of separating webs 9 are vent chambers 86 that enclose vent openings 81 on the inner side of the cartridge. Vent chambers 86 serve on the one hand for structural reinforcement of cartridge bottom 4 in the region of vent openings 81, so that deformation upon coupling of cartridge 1 to dispenser 2 is prevented, and on the other hand for connection between vent openings 81 and vent conduits 82. As is visible in particular from FIGS. 23 to 25, vent chambers 86 are of cuboidal configuration. Vent chambers 86 are connected communicatingly to vent conduit 82 (not evident from FIGS. 22 to 25).

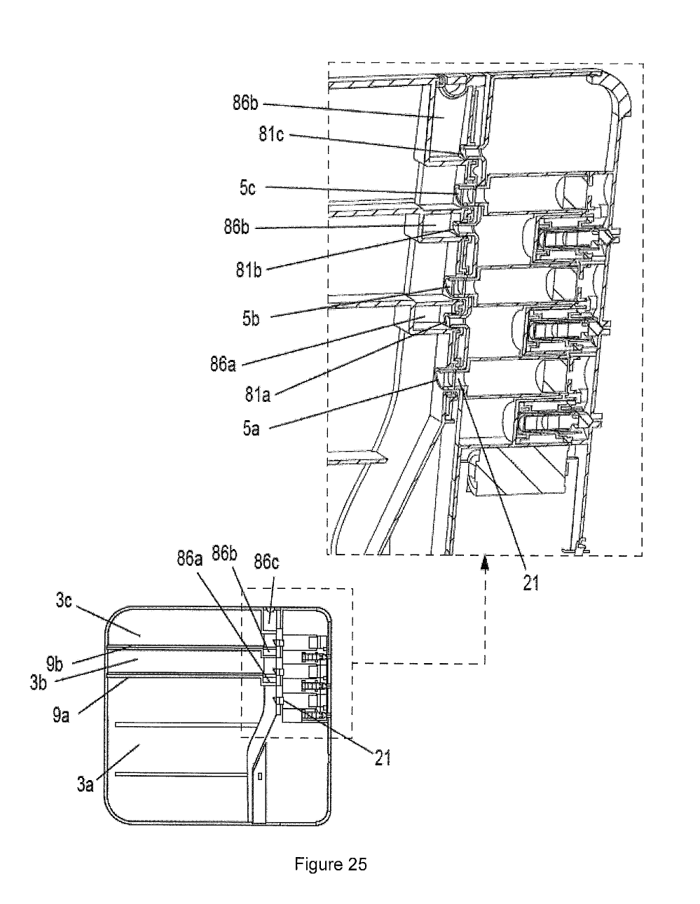

FIG. 25 is a cross-sectional view of cartridge 1 and the dispenser in the coupled state. It is evident that when dispenser 2 and cartridge 1 are in the coupled state, inlets 21 of peg-like configuration project into the interior of cartridge chambers 3 or vent chambers 86, peg-like inlets 21 of dispenser 2 embodying a liquid-tight connection with outlet openings 5 of the cartridge so that preparation can travel out of chambers 3 only through the interior of the peg-like inlets 21 into dispenser 2.

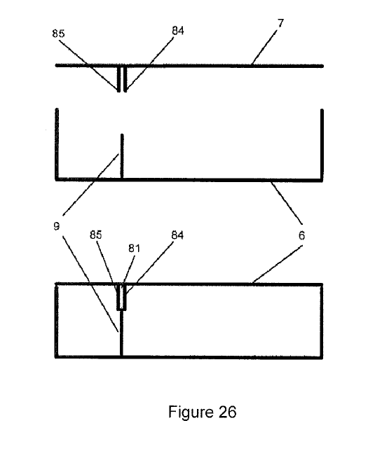

FIG. 26 schematically depicts the shaping of a vent conduit by joining two cartridge elements 6, 7. In the upper part of FIG. 26, the two cartridge elements 6, 7 are illustrated in the state separated from one another. Cartridge element 7 is of plate-like configuration, two webs 84, 85 spaced apart from one another extending perpendicular to cartridge element 7. Webs 84, 85 are configured so that they can surround a web 9 shaped on cartridge element 6; this is visible in the lower part of FIG. 26. The fit is selected so that the inner sides of webs 84, 85 readily touch web 9. With cartridge elements 6, 7 in the assembled state, the two webs 84, 85 and web 9 form vent conduit 81. It is particularly advantageous to bond the ends of webs 84, 85 to web 9, in particular by welding.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A cartridge for coupling to a dispenser for delivering at least one washing- and/or cleaning-agent preparation out of the cartridge into the interior of a household appliance, wherein:
the cartridge encompasses at least one chamber for stocking at least one flowable or pourable washing- and/or cleaning-agent preparation; and
at least one light guide, into which a light signal can be coupled from outside the cartridge, is arranged in or on the cartridge.

2. The cartridge according to claim 1, wherein the cartridge encompasses at least two chambers.

3. The cartridge according to claim 2, wherein the chambers are separated from one another by separating webs.

4. The cartridge according to claim 2, wherein the light guide is shaped entirely or partly into or onto walls and/or webs of the cartridge.

5. The cartridge according to claim 3, wherein the light guide is shaped integrally into or onto walls and/or webs of the cartridge.

6. The cartridge according to claim 1, wherein the light guide is shaped from a transparent plastic material.

7. The cartridge according to claim 1, wherein the cartridge is formed from a transparent material.

8. The cartridge according to claim 6, wherein the light guide is suitable for guiding light in the visible region (380 to 780 nm).

9. The cartridge according to claim 1, wherein the light guide is suitable for guiding light in the near infrared region (780 nm to 3000 nm).

10. The cartridge according to claim 1, wherein the light guide is suitable for guiding light in the medium infrared region (3.0 μm to 50 μm).

11. The cartridge according to claim 1, wherein the light guide is suitable for guiding light in the far infrared region (50 μm to 1 mm).

12. The cartridge according to claim 1, wherein the light signal that can be coupled into the light guide is a carrier of information regarding the operating state of the dispenser and/or the fill level of the cartridge.

13. The cartridge according to claim 12, wherein the light guide is configured so that the light signal that can be coupled into the light guide can be coupled out of the light guide.

14. The cartridge according to claim 13, wherein the light guide is configured so that the light signal can be coupled out at a point on the cartridge that is different from the point at which the light signal can be coupled into the cartridge.

15. The cartridge according to claim 12, wherein a light signal can be coupled in or out at a prismatically embodied edge of the cartridge.

16. The cartridge according to claim 1, wherein the light signal and the light guide are configured in such a way that a light signal visible to a user can be generated on and/or in the cartridge.

17. The cartridge according to claim 1, wherein the light guide is, at least locally, surrounded entirely or partly by a material having a lower optical refractive index.

18. The cartridge according to claim 17, wherein the material having the lower optical refractive index is a preparation stocked in a chamber of the cartridge.

19. The cartridge according to claim 17, wherein the light guide is severed at at least one point in the cartridge in such a way that the preparation can fill the severed point.

20. A dispenser for delivering at least one washing- and/or cleaning-agent preparation out of a cartridge according to claim 1 and into the interior of a household appliance, wherein a light signal can be coupled, by means of a light source present on the dispenser, into a light guide of the cartridge.

21. The dispenser according to claim 20, wherein the light source is an LED.

22. The dispenser according to claim 20, wherein the light signal coupled into the light guide of the cartridge and passing through the light guide can be sensed by a sensor present on the dispenser.
